(19) United States
(12) Patent Application Publication
(10) Pub. No.: US 2016/0046020 A1
(43) Pub. Date: Feb. 18, 2016

(54) SELECTIVE COMPLIANCE ASSEMBLY ROBOT ARM

(71) Applicant: HIWIN TECHNOLOGIES CORP., Taichung City (TW)

(72) Inventors: Yung-Tsai CHUO, Taichung City (TW); Fu-Ching WANG, Taichung City (TW); Chia-Yu CHENG, Taichung City (TW); Yu-Jung CHANG, Taichung City (TW); Yao-Hui CHEN, Taichung City (TW)

(21) Appl. No.: 14/460,903

(22) Filed: Aug. 15, 2014

(51) Int. Cl. B25J 9/16; B25J 19/00; B25J 18/04

(52) U.S. Cl. CPC B25J 9/1615; B25J 18/04; B25J 19/0029; Y10S 901/23; Y10S 901/25; G05B 2219/40301

(57) ABSTRACT

A SCARA arm includes a base, a first arm, a second arm, a third linear shaft motor, and a fourth shaft motor. On the base is disposed a first shaft motor. The first arm is connected to and driven by the first shaft motor rotate in a horizontal direction. The second arm is fixed to a second shaft motor which is connected to the first arm to rotate the second arm in the horizontal direction. The third linear shaft motor includes a linear motor stator which extends in a vertical direction and is fixed to the second arm, and a linear motor mover which is sleeved onto the linear motor stator and movable along the vertical direction. The fourth shaft motor is drivingly connected to the linear motor mover and a rotary shaft, respectively, and another end of the rotary shaft is inserted out of the second arm.

### BACKGROUND OF THE INVENTION

1. Field of the Invention

The present invention relates to a mechanic arm, and more particularly to a SCARA arm.

2. Description of the Prior Art

SCARA (selective compliance assembly robot arm) is also called selective compliance articulated robot arm and includes three horizontally-rotary joints and a vertically-movable joint. Therefore, SCARA is rigid in the horizontal direction and movable or rotatable in the vertical direction.

FIG. 1 shows a conventional SCARA arm 10 essentially comprises a base 11 and a big arm 12 disposed on the base 11 and driven to rotate in the horizontal direction by a first motor 111 and a first rotary shaft 112. A small arm 13 which is equipped with a second motor 131 is connected to the big arm 12 via a second rotary shaft 132, and the second rotary shaft 132 drives the small arm 13 to rotate in horizontal direction. Inside the small arm 13 is disposed a third motor 133 and a screw 134. The third motor 133 drives a third rotary shaft 135 to rotate, and then the third rotary shaft 135 drives the screw 134 to rotate via a belt 14. Onto the screw 134 is sleeved a nut 15. When the screw 134 rotates, the nut 15 can drive a fourth rotary shaft 16 to move vertically. Meanwhile, the fourth rotary shaft 16 can also be driven to rotate by a fourth motor 17.

The belt 14 is likely to wear off and fatigue, and therefore must be replaced regularly. However, the replacement of the belt 14 requires removal of the small arm 13 and relative components, which is troublesome and will increase maintenance cost. In addition, using the belt 14 to drive the third rotary shaft 135 and the screw 134 is a kind of indirect drive (transmission), which has the disadvantages of low drive efficiency and accuracy, and low stability.

The present invention has arisen to mitigate and/or obviate the afore-described disadvantages.

### SUMMARY OF THE INVENTION

The primary objective of the present invention is to provide a SCARA arm, which is free of the above mentioned disadvantages of low drive efficiency and accuracy, and low stability.

To achieve the above objective, a SCARA arm in accordance with the present invention comprises: a base, a first arm, a second arm, a third linear shaft motor, and a fourth shaft motor.

On the base is disposed a first shaft motor.

The first arm has one end connected to the first gear reduction mechanism of the first shaft motor and is driven to rotate in a horizontal direction by the first shaft motor.

The second arm has one end fixed to a second shaft motor, and the second shaft motor is connected to another end of the first arm to drive the second arm to rotate in the horizontal direction.

The third linear shaft motor includes a linear motor stator and a linear motor mover, the linear motor stator extends in a vertical direction perpendicular to the horizontal direction and being fixed to the second arm, and the linear motor mover is sleeved onto the linear motor stator and movable along the vertical direction.

The fourth shaft motor is drivingly connected to the linear motor mover and connected to one end of a rotary shaft, so as to drive the rotary shaft to rotate, another end of the rotary shaft is inserted out of the second arm.

The SCARA arm in accordance with the present invention allows for three levels of horizontal rotation and one vertical linear movement. In addition, the direct drive mode can improve the drive accuracy and stability, without requiring the use of indirect drive member between the drive and driven members. Therefore, the structure of the SCARA arm in accordance with the present invention is simplified, and maintenance cost is also reduced accordingly.

### BRIEF DESCRIPTION OF THE DRAWINGS

FIG. 1 is an illustrative view of a conventional SCARA arm;

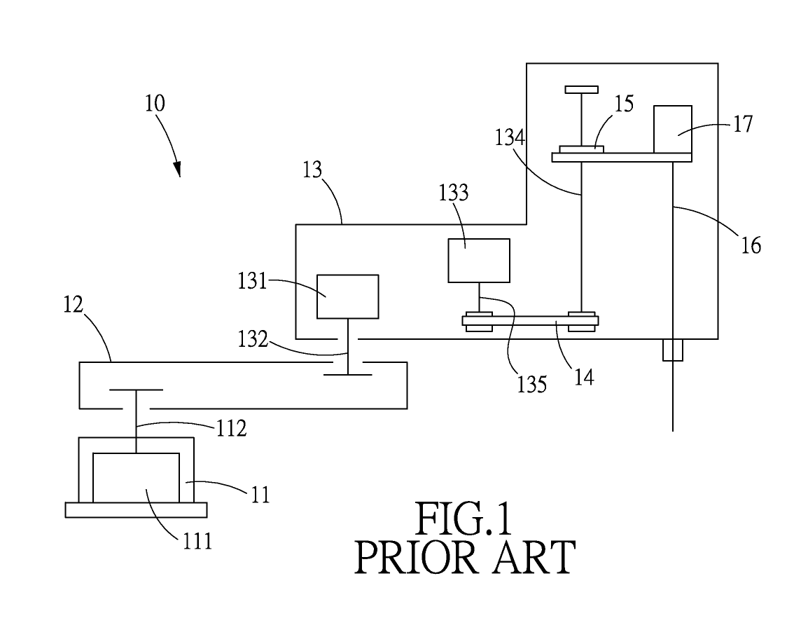

FIG. 2 is a perspective view of a SCARA arm in accordance with a preferred embodiment of the present invention;

FIG. 3 is another perspective view of the SCARA arm in accordance with the present invention;

FIG. 4 is a cross sectional view of the SCARA arm in accordance with the present invention;

FIG. 5 is a perspective view of the SCARA arm in accordance with the present invention, showing that the linear guide unit is disposed at a different position than the first embodiment; and

FIG. 6 is a perspective view of the SCARA arm in accordance with the present invention, showing another type of linear guide unit.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

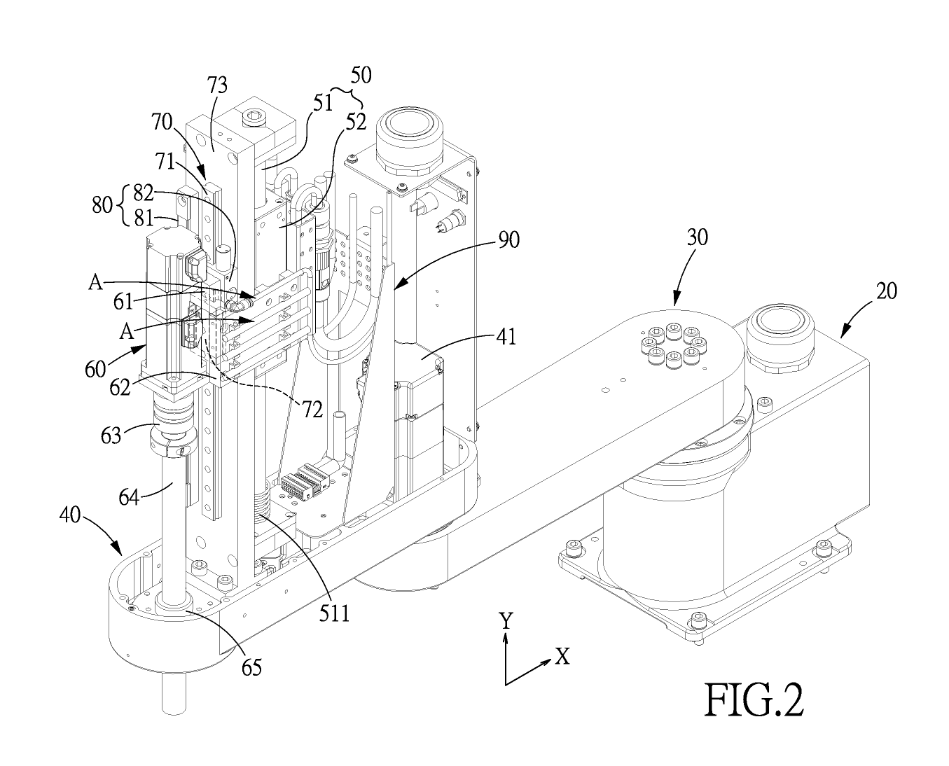

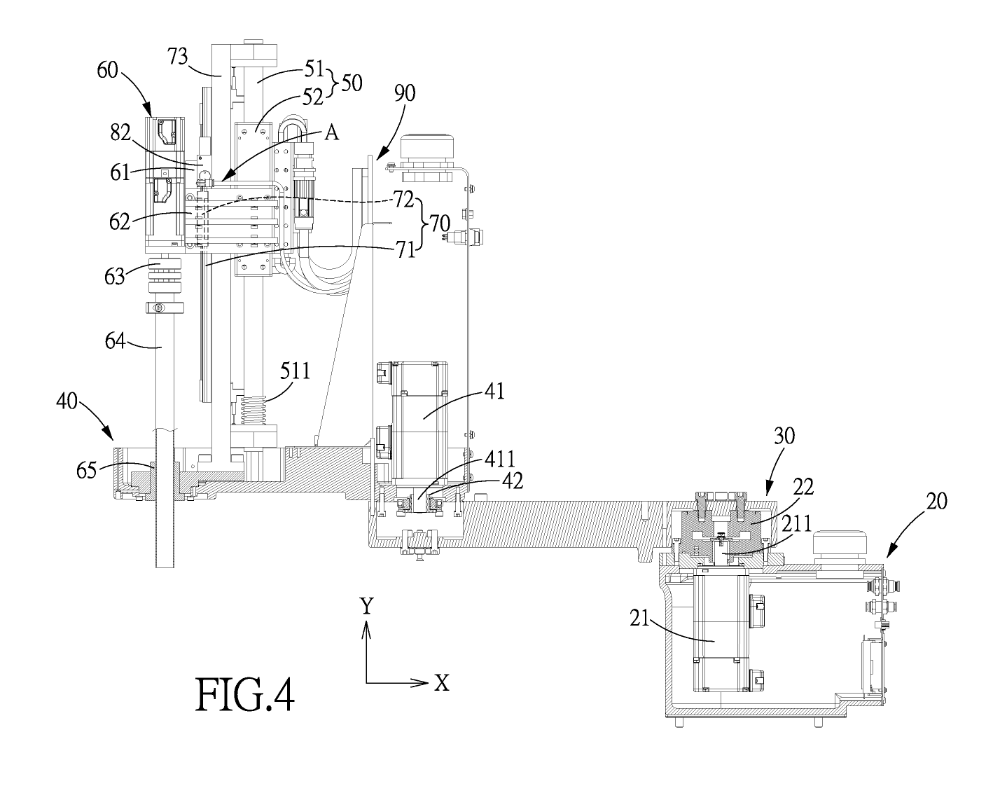

Referring to FIGS. 2-6, a SCARA arm in accordance with a preferred embodiment of the present invention comprises: a base 20, a first arm 30, a second arm 40, a third linear shaft motor 50, a fourth shaft motor 60, a linear guide unit 70, a linear position control unit 80, and a cable frame 90.

The base 20 is fixed to the ground or a stationary surface. On the base 20 is disposed a first shaft motor 21 to rotate a first rotary shaft 211 which extends in a vertical direction Y, and a direction perpendicular to the vertical direction Y is defined as a horizontal direction X. The first rotary shaft 211 is drivingly connected to a first gear reduction mechanism 22, so that the first shaft motor 21 outputs power from the first gear reduction mechanism 22.

The first arm 30 has one end connected to the first gear reduction mechanism 22 of the first shaft motor 21, so that the first arm 30 can be driven to rotate around the first rotary shaft 211 in the horizontal direction X by the first shaft motor 21.

The second arm 40 has one end fixed to a second shaft motor 41 which drives a second rotary shaft 411 to rotate. The second rotary shaft 411 is drivingly connected to a second gear reduction mechanism 42, so that the second shaft motor 41 outputs power from the second gear reduction mechanism 42 which is connected to another end of the first arm 30. By such arrangements, the second arm 40 can be driven to rotate around the secondary rotary shaft 411 in the horizontal direction X by the second arm 40.

The third linear shaft motor 50 is fixed to the second arm 40 and includes a linear motor stator 51 and a linear motor mover 52. The linear motor stator 51 extends in the vertical direction Y and is fixed to the second arm 40. The linear motor mover 52 is electrically connected to a drive controller (not shown) and sleeved onto the linear motor stator 51. The linear motor mover 52 is controlled by the drive controller to linearly move in the vertical direction Y with respect to the linear motor stator 51. The third linear shaft motor 50 can also be used in combination with a Hall sensor, and the Hall sensor can easily detect motor angle when the third linear shaft motor 50 is started, ensuring smoothing running of the third linear shaft motor 50. Or, a positioning member 511 can be sleeved onto the linear motor stator 51, as shown in FIGS. 2-4, to restrict the linear motor mover 52 at the position of a correct motor angle, without having to detect the motor angle when the third linear shaft motor 50 is started. In this embodiment, the positioning member 511 is a spiral spring.

The fourth shaft motor 60 is drivingly connected to the linear motor mover 52. In this embodiment, the fourth shaft motor 60 is fixed to a driven member 62 by a fourth-shaft-motor fixing plate 61, namely, the fourth shaft motor 60 is fixed on the fourth-shaft-motor fixing plate 61, the fourth-shaft-motor fixing plate 61 is fixed to the driven member 62, and then the driven member 62 is fixed to the linear motor mover 52. The linear motor mover 52 is drivingly connected to the fourth shaft motor 60 via the driven member 62. The fourth shaft motor 60 is also drivingly connected to one end of a rotary shaft 64 by a coupling member 63, so as to drive the rotary shaft 64 to rotate. Another end of the rotary shaft 64 is exposed out of the second arm 40 by inserting through a ball bearing 65 which is fixed at the second arm 40.

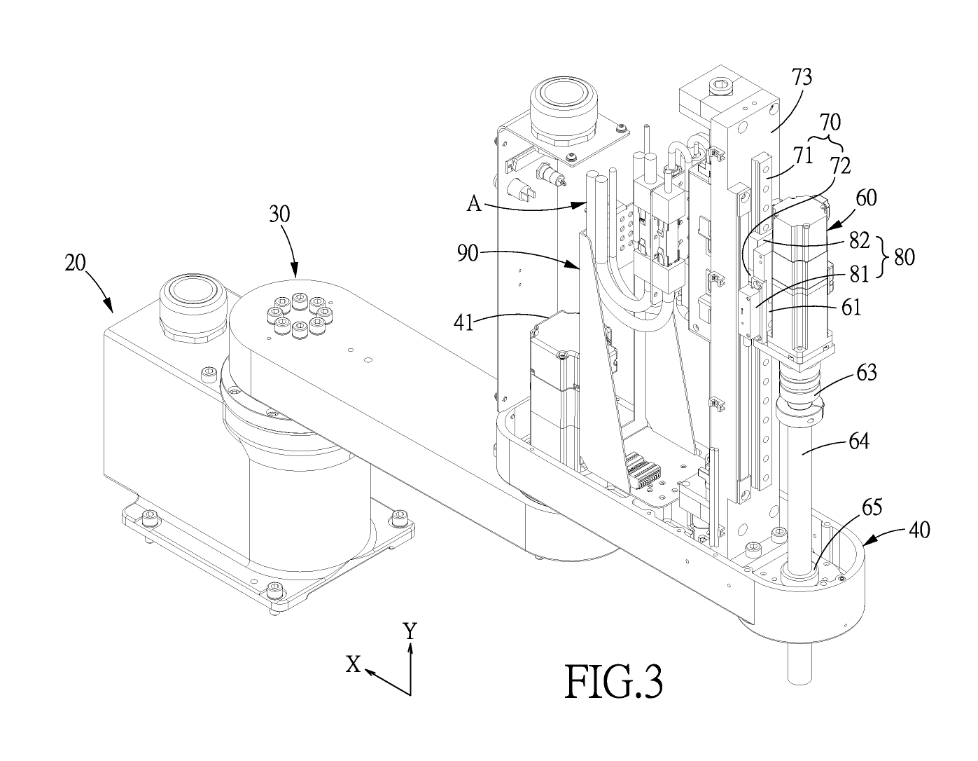

The linear guide unit 70 is fixed at the second arm 40 to guide the linear movement of the fourth shaft motor 60, and includes a linear guide portion 71 and a linear slide portion 72. The linear guide portion 71 is fixed to the second arm 40 by a linear-rail fixing plate 73, namely, the linear-rail fixing plate 73 is fixed on the second arm 40, and the linear guide portion 71 is then fixed at the linear-rail fixing plate 73. The linear slide portion 72 is fixed to the fourth-shaft-motor fixing plate 61 and guided by the linear guide portion 71 to move in a linear manner. As shown in FIGS. 2 and 3, the linear guide portion 71 is a linear rail, and the linear slide portion 72 is a slide block.

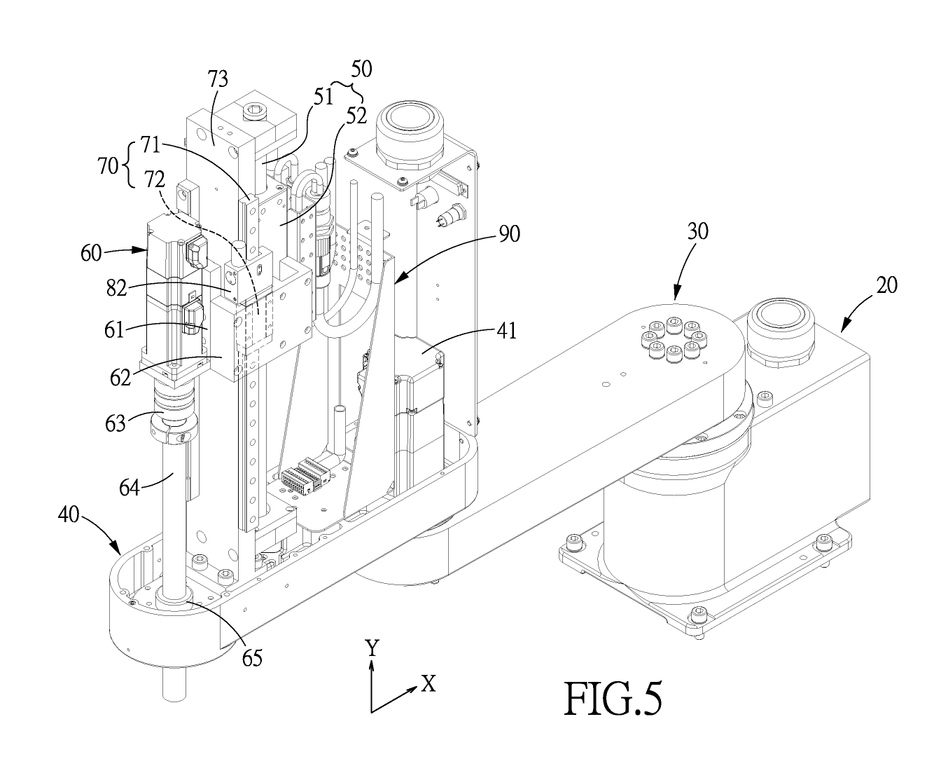

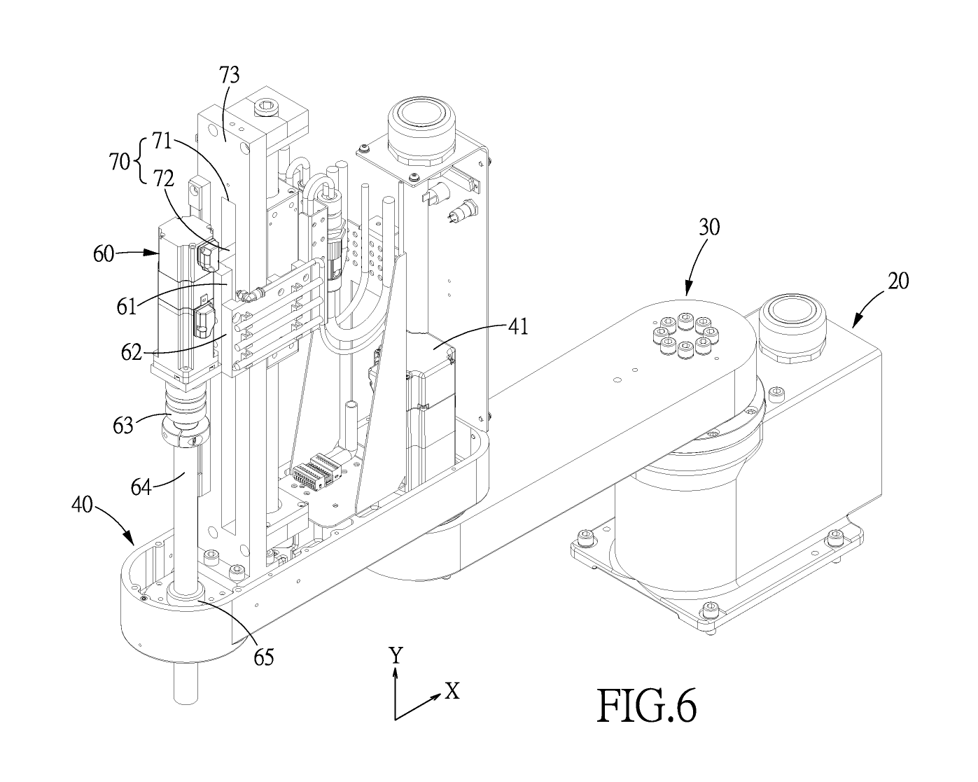

The device for guiding the linear movement of the fourth shaft motor 60 is not limited to the structure of the linear guide unit 70 as shown in FIGS. 2 and 3. For example, the linear guide portion 71 can be fixed on a surface of the linear-rail fixing plate 73 that faces the fourth shaft motor 60, as shown in FIGS. 2 and 3. Or, the linear guide portion 71 can also be disposed on a lateral surface of the linear-rail fixing plate 73, as shown in FIG. 5, as long as the driven member 62 is drivingly connected to the linear motor mover 52 and the fourth shaft motor 60. Besides, the linear guide unit 70 can also be as shown in FIG. 6, wherein the linear guide portion 71 is a linear slot formed in the linear-rail fixing plate 73, and the linear slide portion 72 is a protrusion formed on the fourth-shaft-motor fixing plate 61. The fourth shaft motor 60 is driven by the driven member 62 to linearly move along the linear guide unit 70.

The linear position control unit 80 includes a position detector 81 and a rail clamping device 82. The position detector 81 is connected to the drive controller and the rail clamping device 82, and fixed on the linear-rail fixing plate 73 to detect the position of the fourth shaft motor 60. The rail clamping device 82 is located at two sides of the linear guide portion 71 and fixed at the linear slide portion 72. The position detector 81 detects the position of the fourth shaft motor 60 and send feedback signal to the drive controller to control the third linear shaft motor 50 and the rail clamping device 82.

The cable frame 90 is fixed on the second arm 40. Plural electric cables A have one ends fixed to the linear motor mover 52, the fourth shaft motor 60 and the rail clamping device 82, respectively, and have another ends abutted against the cable frame 90. The electric cables A connected to the fourth shaft motor 60 and the rail clamping device 82 climb over the driven member 62 and are leaned against the cable frame 90. The portions of the electric cables A that come into contact with the driven member 62 are fixed to the driven member 62, so that the electric cables A that climb over the driven member 62 will move along with the driven member 62. When the electric cables A are moving, another ends of the electric cables A are leaned against the cable frame 90, so as to prevent undesired swinging of the electric cables A.

The first shaft motor 21 can rotate the first arm 30, and the second shaft motor 41 rotates the second arm 40, and then the third linear shaft motor 50 can drive the linear motor mover 52 to move linearly with respect to the linear motor stator 51 in the vertical direction Y.

Since the linear motor mover 52 and the fourth shaft motor 60 is connected by the fourth-shaft-motor fixing plate 61 and the driven member 62, when the linear motor mover 52 moves in the vertical direction Y, the movement of the linear motor mover 52 will cause the fourth shaft motor 60 and the rotary shaft 64 of the fourth shaft motor 60 to move in the vertical direction Y. At this moment, the rotation of the fourth shaft motor 60 can drive the rotary shaft 64 to move linearly in the vertical direction Y or to rotate in the horizontal direction X. Hence, the SCARA arm in accordance with the present invention allows for three levels of horizontal rotation and one vertical linear movement.

It is to be noted that the drive force supply device for causing vertical motion in the vertical direction Y is the third linear shaft motor 50, and the interior structure of the third linear shaft motor 50 is a non-contact transmission structure, which can reduce running noise.

In addition, the movement in the vertical direction Y is directly driven by the third linear shaft motor 50, and the rotary shaft 64 is directly rotated by the fourth shaft motor 60, the direct drive (transmission) mode can improve the drive accuracy and stability, without requiring the use of indirect drive (transmission) member (such as chain, belt) between the drive and driven members. Therefore, the structure of the SCARA arm in accordance with the present invention is simplified, and maintenance cost is also reduced accordingly.

Since the fourth shaft motor 60 and the rail clamping device 82 can move linearly in the vertical direction Y, the electric cables A have one ends fixed to the fourth shaft motor 60 and the rail clamping device 82, respectively, and have another ends abutted against the cable frame 90. When the electric cables A are moving along with the fourth shaft motor 60 and the rail clamping device 82, another ends of the electric cables A are leaned against the cable frame 90, so as to prevent undesired swinging of the electric cables A.

While we have shown and described various embodiments in accordance with the present invention, it is clear to those skilled in the art that further embodiments may be made without departing from the scope of the present invention.

What is claimed is:

1. A selective compliance assembly robot arm comprising:
a base, on which being disposed a first shaft motor;
a first arm with one end connected to the first gear reduction mechanism of the first shaft motor being driven to rotate in a horizontal direction by the first shaft motor;
a second arm with one end fixed to a second shaft motor, the second shaft motor being connected to another end of the first arm to drive the second arm to rotate in the horizontal direction;
a third linear shaft motor including a linear motor stator and a linear motor mover, the linear motor stator extending in a vertical direction perpendicular to the horizontal direction and being fixed to the second arm, the linear motor mover being sleeved onto the linear motor stator and movable along the vertical direction; and
a fourth shaft motor being drivingly connected to the linear motor mover and being connected to one end of a rotary shaft, so as to drive the rotary shaft to rotate, another end of the rotary shaft being inserted out of the second arm.

2. The selective compliance assembly robot arm as claimed in claim 1, wherein the fourth shaft motor is fixed to a driven member by a fourth-shaft-motor fixing plate, and then the driven member is fixed to the linear motor mover, so that the linear motor mover is drivingly connected to the fourth shaft motor.

3. The selective compliance assembly robot arm as claimed in claim 1, wherein a linear guide unit is fixed at the second arm to guide linear movement of the fourth shaft motor, and includes a linear guide portion and a linear slide portion, the linear guide portion is fixed to the second arm, and the linear slide portion is fixed to the fourth-shaft-motor fixing plate and guided by the linear guide portion to move in a linear manner.

4. The selective compliance assembly robot arm as claimed in claim 3, wherein the linear guide portion is a linear rail, the linear slide portion is a slide block, the linear guide portion is fixed to the second arm by a linear-rail fixing plate, the fourth shaft motor is fixed to a fourth-shaft-motor fixing plate, and the linear guide portion is fixed to the fourth-shaft-motor fixing plate.

5. The selective compliance assembly robot arm as claimed in claim 3, wherein the linear guide portion is fixed to the second arm by a linear-rail fixing plate and is a linear slot formed in the linear-rail fixing plate, the fourth shaft motor is fixed to a fourth-shaft-motor fixing plate, and the linear slide portion is a protrusion formed on the fourth-shaft-motor fixing plate.

6. The selective compliance assembly robot arm as claimed in claim 1, wherein a linear position control unit is disposed on the second arm to detect the position of the fourth shaft motor.

7. The selective compliance assembly robot arm as claimed in claim 1, wherein the linear guide unit is used in combination with a rail clamping device which is located at two sides of the linear guide portion and fixed at the linear slide portion.

8. The selective compliance assembly robot arm as claimed in claim 1, wherein a cable frame is fixed on the second arm, and plural electric cables have one ends fixed to the linear motor mover, the fourth shaft motor and the rail clamping device, respectively, and have another ends abutted against the cable frame.

9. The selective compliance assembly robot arm as claimed in claim 2, wherein a cable frame is fixed on the second arm, plural electric cables have one ends fixed to the linear motor mover, the fourth shaft motor and the rail clamping device, respectively, and have another ends abutted against the cable frame, and the electric cables have middle portions between two ends thereof fixed to the driven member.

10. The selective compliance assembly robot arm as claimed in claim 1, wherein a positioning member is sleeved onto the linear motor stator to restrict the linear motor mover at a position of a desired motor angle, and the positioning member is a spiral spring.
